(19) United States
(12) Patent Application Publication
(10) Pub. No.: US 2007/0000286 A1
(43) Pub. Date: Jan. 4, 2007

(54) Fiberizing spinner for the manufacture of low diameter, high quality fibers

(76) Inventors: Patrick M. Gavin, Newark, OH (US); Todd M. Harms, Delaware, OH (US); Michael T. Pellegrin, Newark, OH (US); Thomas F. Metzger, Somerset, OH (US)

Correspondence Address: OWENS CORNING, 2790 COLUMBUS ROAD, GRANVILLE, OH, 43023, US

(21) Appl. No.: 11/173,429

(22) Filed: Jul. 1, 2005

(51) Int. Cl. C03B 37/07; C03B 37/04; G01N 21/00; F27B 7/00

(52) U.S. Cl. 65/377; 65/459; 65/521

(57) ABSTRACT

An apparatus for manufacturing low diameter, high quality glass wool fibers, and more particularly to a spinner for centrifuging low diameter glass wool fibers to improve light-density building insulation is disclosed. The spinner includes a number of glass orifices positioned predetermined column angle and provides a hole pattern that improves the quality of the glass. The improved hole pattern is determined by experimentation and may be implemented in any glass fiberization process.

### TECHNICAL FIELD AND INDUSTRIAL APPLICABILITY OF THE INVENTION

The present invention relates to an apparatus for manufacturing low diameter, high quality glass wool fibers, and more particularly to a spinner for centrifuging low diameter glass wool fibers to improve light-density building insulation.

### BACKGROUND OF THE INVENTION

Fibers of glass and other thermoplastic materials are useful in a variety of applications including acoustical and thermal insulation materials. Common prior art methods for producing fiberglass insulation products involve producing glass fibers from a rotary process. In a rotary process, glass composition is melted and forced through orifices in the outer peripheral wall of a centrifuge, commonly known as a centrifugal spinner, to produce the fibers. One commonly used spinner is generally cup-shaped that has a bottom wall with a central hole, a top opening and an outer peripheral sidewall that curves upward from the bottom wall, forming the top opening. Another commonly used spinner uses a slinger cup to propel the glass composition to the sidewall for fiberization. A drive shaft is used to rotate the spinner and is typically fixed to the spinner with a quill.

During fiberization, the spinner is subjected to high temperatures and high rotational speeds that exert substantial force on the spinner. An external burner forces a jet of hot gas onto the fibers as they are extruded through the orifices of the sidewall to heat the fibers, and an external blower is used to stretch the fibers.

The peripheral sidewall includes a large number (typically 20,000 - 40,000) of holes distributed across the face of the sidewall. The holes through the sidewall of the spinner weaken the face, which may cause in a catastrophic failure of the spinner during fiberization. The failure of a spinner is generally caused by vertical or horizontal cracks that grow from one hole to another along the sidewall. To avoid this cracking, the hole patterns of the prior art spinners are generally designed to spread the holes across the entire face of the sidewall to maximize the distance between adjacent holes. Generally, as shown in FIGS. 1A-1C, the orifices 114 are arranged on the sidewall 110 of the spinner in a series of parallel columns 116 that are positioned at a column angle of 60 ° from the horizontal of sidewall 110. Adjacent columns are spaced by a distance (d) to form a close packed pattern having a 60° column angle, and forming a vertical row 118 of orifices.

The R-value of an insulation batt can be determined by the thickness (T) of the fibrous insulation and the thermal conductivity (k) using equation 1.

$$R = \frac{T}{k} \qquad ( 1 )$$

R-value may be increased by decreasing the thermal conductivity, k, of the insulation. Decreased k-values are typically obtained by increasing the density of the insulation or by decreasing the fiber diameter of the insulation. Increased R-value through increased density is well known; however, the increased density increases the material costs of the insulation. Decreasing the fiber diameter is also well known and k curves are well established to anticipate the decrease in k-value based on decreased fiber diameter. Glasswool having an increased k-value above what is expected from the established K-curves, without increased density, is referred to herein as “high quality wool” or “high quality” fibers.

It has been discovered that lower diameter, higher quality fibers can be produced by deviating from the prior art in two ways, either separately or in combination. The first change consists of locating the spinner hole pattern as close as possible to the top of the spinner sidewall. The second change consists of drilling the spinner holes so that the diagonal alignment, or “column angle” shown in FIGS. 1A-1C, is in an orientation that minimizes the interactions between fibers while they are being formed.

### SUMMARY OF THE INVENTION

The need to control fiber diameter and improve glasswool quality is met by a spinner according to the present invention. The spinner of the present invention is adapted to control the position of the orifices with respect to one another and to control the position of the orifices in the spinner sidewall.

The orifices are arranged at a predetermined column angle, typically less than 45° and preferably of about 30°. The predetermined column angle results in a hole pattern which allows the fibers to be extruded from the spinner and impinged by burner and blower jets with a decreased chance of fiber-to-fiber interactions. These fiber-to-fiber interactions are presumed to reduce the quality of the glasswool by decreasing fiber strength and increasing fiber entanglement. Conventional hole patterns were designed primarily to improve the mechanical strength of the spinner, by maximizing the distance between orifices, and without consideration for the interaction of fibers.

The improvement is also achieved by drilling the orifices in the spinner at a reduced distance along the vertical so that the orifices are grouped at the upper end of the sidewall, preferably leaving a void at the lower end of the sidewall. It has been discovered that grouping the orifices at the upper edge of the sidewall results in a reduced fiber diameter due to the aerodynamic drag forces imparted to the fibers by the gases exiting the blower and the burner. The force from the blower and burner jets decreases with distance from the origin of the jet. By concentrating the orifices at the upper edge of the spinner, the fibers exiting the spinner are subjected to higher forces and are attenuated to a greater degree. The greater attenuation of the primary fibers results in a lower diameter fiber in the insulation.

The objectives, features, and advantages of the present invention will become apparent upon consideration of the description herein and the appended claims and drawings.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1A is a schematic view of a section of a prior art spinner showing the hole pattern extending across substantially the entire height of the spinner sidewall.

FIG. 1B is a schematic view of a section of a prior art spinner showing the arrangement of orifices in diagonal columns and vertical files.

FIG. 1C is a detail of FIG. 1B showing the alignment of vertical rows and diagonal columns in a prior art spinner.

FIG. 2A is a schematic view of a section of a spinner, according to the present invention, showing the hole pattern extending across a portion of the height of the spinner sidewall.

FIG. 2B is a schematic view of a section of a spinner showing the arrangement of orifices in diagonal columns and vertical files.

FIG. 2C is a detail of FIG. 2B showing the alignment of vertical rows and diagonal columns;

FIG. 3 is a partially schematic cross-sectional view in elevation of a fiberizer with a spinner according to the principles of the present invention.

FIG. 4 is a graph depicting the relationship of thermal conductivity to fiber diameter showing the improvement in thermal conductivity of fibers manufactured using the spinner of the present invention.

FIG. 5 is a graph depicting the relationship of the impact of column angle on fiber diameter.

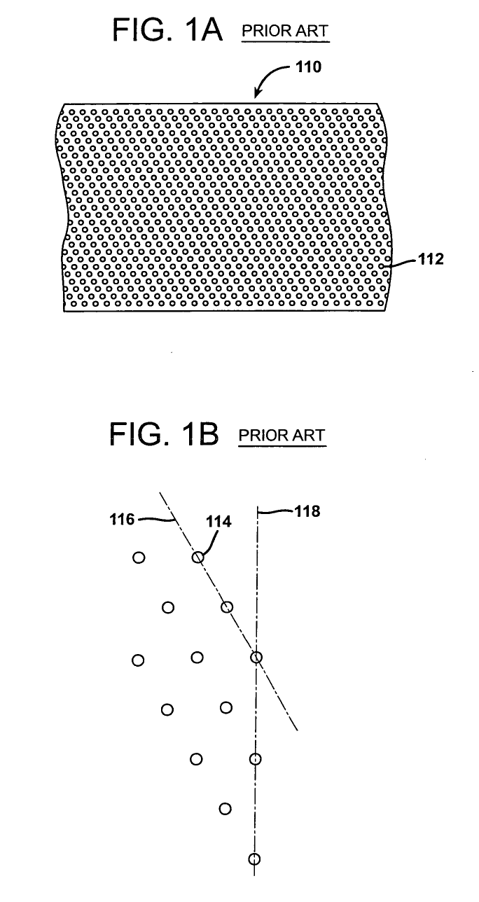

### DETAILED DESCRIPTION AND PREFERRED EMBODIMENTS OF THE INVENTION

Although the present invention is herein described in terms of specific embodiments, it will be readily apparent to those skilled in this art that various modifications, rearrangements, and substitutions can be made without departing from the spirit or scope of the invention. The scope of the present invention is thus only limited by the claims appended hereto.

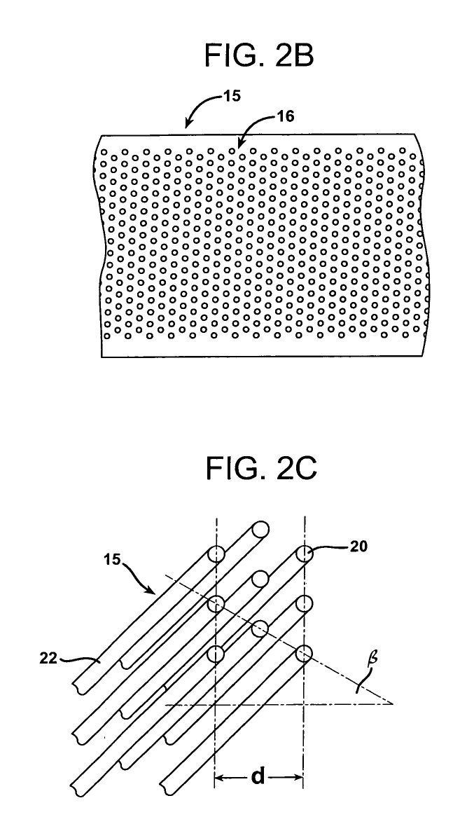

Referring to FIG. 3, the fiberizer 10 includes a spinner 12 fixed to the lower end of a rotatable shaft or spindle 14. Rotating the spinner 12 by rotating spindle 14 is known in the art. The spinner 12 includes a base 18 extending from spindle 14 to the peripheral wall 18. Disposed around the outer periphery of the peripheral wall 18 is a plurality of orifices 20 for centrifuging fibers 22 of a molten thermoplastic material, for example, glass.

The spinner 12 that is supplied with a stream 78 of a molten thermoplastic material. Conventional supply equipment 82 can be used to supply stream 78 of molten glass. Such molten glass supply equipment is well known in the industry and, therefore, will not be discussed in detail herein. The glass in stream 78 drops into the chamber 42 of spinner 12 and through centripetal force is directed against the peripheral wall 18 and flows outwardly to form a build-up or head 90 of glass. The glass then flows through the orifices 20 to form primary fibers 22, which are heated and stretched by burners 24 and annular blower 28.

The rotation of the spinner 12 (as depicted by the circular arrow (α) in FIG. 3) centrifuges molten glass through orifices 20 in spinner peripheral wall 18 to form primary fibers 22. The primary fibers 22 are maintained in a soft, attenuable condition by the heat of an annular burner 24. The annular blower 28 uses induced air through passage 30 to pull primary fibers 22 and further attenuate them into secondary fibers 32 suitable for use in a product, such as wool insulating materials. The secondary fibers 32 are then collected on a conveyor (not shown) for formation into a product, such as a glass wool pack.

Optionally, a frustoconical or truncated cone shaped quill pan 46 is used to substantially cover the bottom of spinner 12. Quill pan 46 may include a plurality of circumferentially separated spacers 48 formed along shield 46 where shield 46 meets the base of spinner 12. These spacers 48 maintain the shield 46 a minimum distance from the spinner 12. The quill pan 46 is typically a separate element from peripheral wall 18 so that the mass of shield 46 has little, if any, effect on the radial balance of the spinner 12. Both the spinner 12 and the fiber shield 46 are mounted on a hub 54. It is desirable for the spinner 12 and the hub 54 to be made from materials having similar coefficients of expansion. The hub 54 is mounted for rotation with the lower end of spindle 14. Hub 54 may include a lower circular shoulder 56, upon which the shield 46 rests and , preferably, is bolted.

A hollow quill 64 is press fit in a borehole formed through the center of hub 54 and locked in place with three circumferentially spaced locking pins 66. The upper end of the quill 64 is threaded into the lower end of a hollow drawbar 68. The drawbar 68 is spring loaded at the upper end of spindle 14 to draw plate 62, along with quill 64 and hub 54, up against the lower end of spindle 14. The quill 64 is partially cooled by circulating air through a stepped bore formed through the drawbar 68 and into another stepped bore formed through the quill 64. The quill 64 is preferably cooled further with water circulated through an annular cooling jacket 70 disposed around spindle 14 and quill 64 and above hub 54. The quill 64 and hub 54 are preferably fabricated from a low thermal expansion alloy to minimize differential thermal expansion between them.

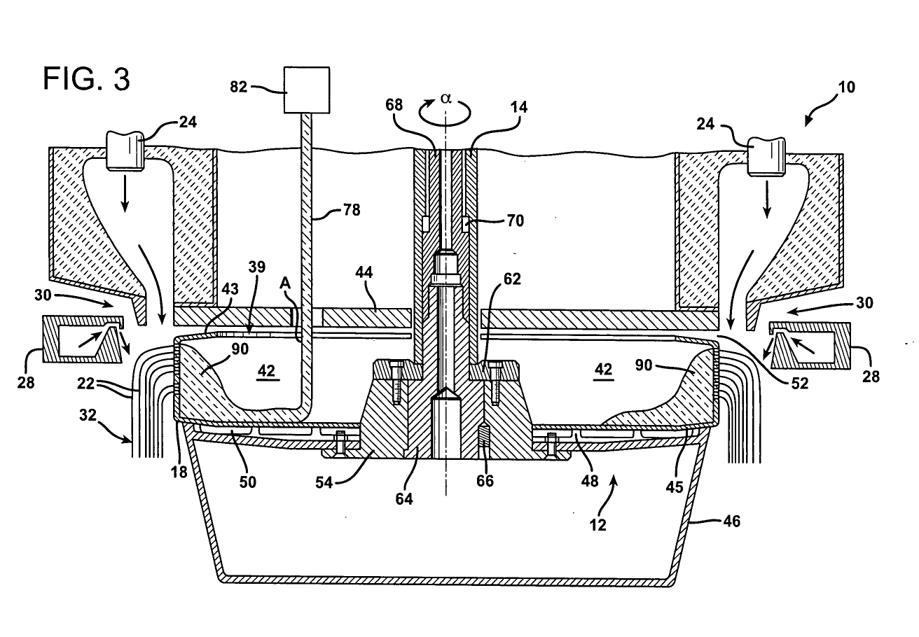

The inventive hole pattern reduces the fiber-to-fiber interaction caused as the primary fibers 22 are extruded. As seen in FIG. 4, the spinner of the present invention provides an improved quality glass wool, as shown by the decrease in k-value below that which is expected by the reduction in fiber diameter.

The spinner of the present invention also improves the hole pattern to reduce contact between primary fibers to increase the quality of the glasswool. As seen in FIG. 4, the hole 30° column angle and row compression reduces the fiber diameter but also improves the k-value of the glasswool more than anticipated by the decrease in fiber diameter. While it is difficult to attribute the improvement in k-value, it is clear from the data that the fiber diameter reduction occurs and the k-value is expected to decrease; however, the k-value is reduced beyond expectations as shown by the reduction in thermal conductivity (k) below the expected k-value shown in the k curve of FIG. 4. Thermal conductivity is measured in k-points where a k-point is a change in the third decimal of the overall k-value. As shown in Eq. 1 (above) an improvement in k-value causes an improvement in overall insulation or R-value. Large producers of glasswool may produce hundreds of millions or billions of pounds of insulation in a year so even small improvements in k-value lead to dramatic savings in material costs. An improvement of approximately 2 k points is due to improvement in the quality of the glasswool. Table 2 shows an overall improvement of 5 k-points from the spinner of the present invention. Of these 5 points 3.4 k-points are attributable to the decrease in fiber diameter and 1.6 K-points are attributed to improvement in the quality of the glasswool.

TABLE 1

| Δk | Δk | Δk |
|---|---|---|
| (total) | (fiber) | (Quality) |
| −5.0 | −3.4 | −1.6 |
| | 69% | 31% |

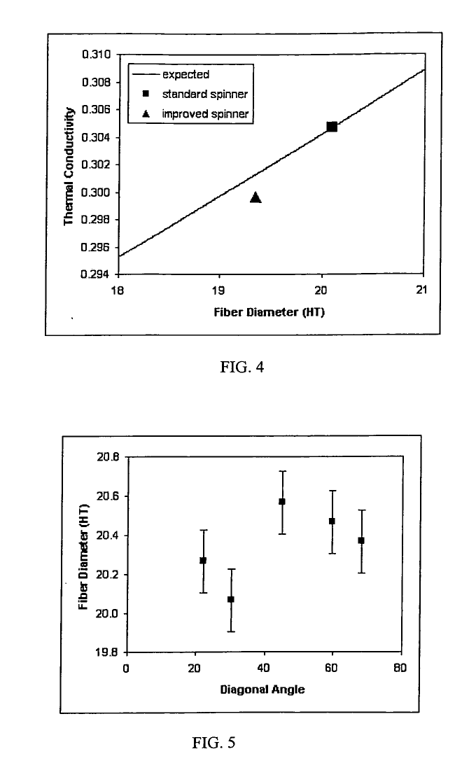

FIG. 5 shows the relation of fiber diameter to diagonal angle and includes the horizontal and vertical spacing in thousandths of an inch (mil) and fiber diameter in hundred- thousandths of an inch.

TABLE 2

| Column | Horizontal | Vertical | Fiber |
|---|---|---|---|
| Angle | Spacing | Spacing | Diameter |
| (°) | (mil) | (mil) | (HT) |
| 68 | 55.7 | 69.0 | 20.4 |
| 60 | 66.8 | 57.1 | 20.5 |
| 45 | 87.3 | 43.5 | 20.6 |
| 30 | 113.3 | 33.3 | 20.1 |

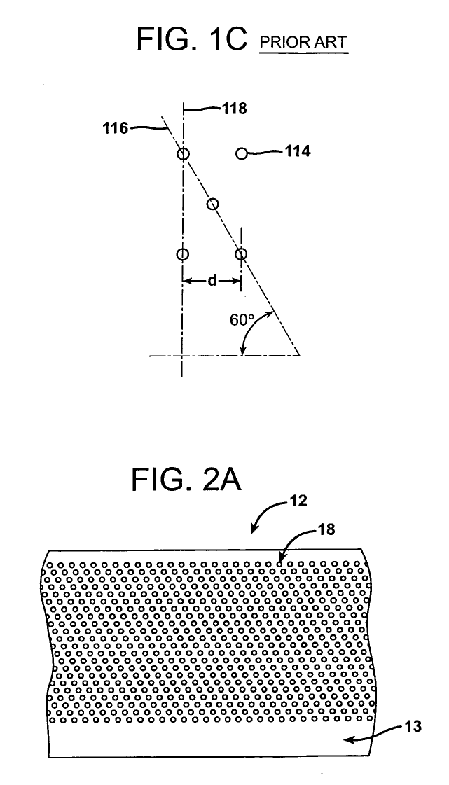

As shown in FIGS. 2B and 2C, the orifices 20 on spinner peripheral wall 18 are positioned diagonal columns 15 and in vertical file 16. Generally, the horizontal rows are formed by succeeding columns 15. It has been discovered that the proximity to the burner 24 and blower 28 to the orifices 20 at the upper end of each vertical file 16 causes the primary fibers 22 formed at the upper orifices to be attenuated to a greater extent than the primary fibers exiting the lower orifices. Therefore, finer fibers are formed at the upper end. In order to take advantage of this phenomenon, the spinner of the present invention includes a high density hole pattern that is packed toward the upper edge of the peripheral sidewall 18.

As seen in detail in FIG. 2C the orifices may be arranged in parallel vertical files 16 and diagonal columns 15. The column angle β (as shown in FIG. 2C) is variable and is selected so as to minimize interactions between fibers during the forming process. These fiber-to-fiber interactions can damage and weaken the fibers, lowering their quality. The preferred diagonal angle cannot presently be calculated, but experiments indicate that both fiber diameter and quality can be significantly affected by the selection of the diagonal angle. For example, angles of approximately 30° provide an improved fiber quality along with an acceptable spinner life.

Hole patterns useful in the present invention include between 20,000 and 40,000holes, although lower and higher hole counts may be used depending upon the desired fiber diameter and insulation density. By compressing the hole pattern against the upper edge of the peripheral sidewall, the fiber diameter may be reduced without changing other process parameters such as glass viscosity, glass temperature, burner temperature and flow, blower temperature and flow, as well as induced air 30 temperature and humidity. By compressing the orifices toward the upper edge of the spinner a nonforaminous band 13 is formed at the base of the spinner. Preferably, spinners fabricated according to the present invention will include a nonforaminous band of between 10% to 50% of the height of the sidewall. Drilling this way reduces the average diameter of the fibers by between 2.5% and 7.5%.

Because of the proximity effect of the burner 24 and blower 28 on the fibers extruded at the upper end of each vertical file 16, it is also contemplated that the diameter of the orifices 18 may be reduced as the distance from the top of the spinner is increased.

Spinners are manufactured in a variety of geometries depending upon the fiberization process used. Typically, major manufacturers of glass fiber have their own fiberization process, which varies from manufacturer to manufacturer; however, the principles of the present invention are equally suitable for use in any rotary fiberization process.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

I claim:

1. A spinner for use in fiberizing thermoplastic fibers, comprising:
a peripheral sidewall having a height and a plurality of orifices formed in said sidewall wherein, said orifices are formed in a band on an upper portion of said sidewall and define an upper foraminous band and a lower substantially non-foraminous band.

2. The spinner of claim 1, wherein said substantially non-foraminous band is at least 10% of the height of the sidewall.

3. The spinner of claim 1, wherein said foraminous band is at least 50% of the height of the sidewall.

4. The spinner of claim 1, wherein said foraminous band is at least 75% of the height of the sidewall.

5. The spinner of claim 1, wherein said foraminous band is at least 90% of the height of the sidewall.

6. A method of improving the k-value of glasswool comprising the steps of:
determining the column angle of a spinner to minimize the thermal conductivity of fibrous insulation batts produced from a spinner; and
manufacturing.

7. The spinner of claim 6, wherein the column angle is approximately 30°.

8. The spinner of claim 6, wherein the column angle is approximately 22°.

9. The spinner of claim 6, wherein the column angle is approximately 45°.

10. The spinner of claim 6, wherein the column angle is approximately 68°.

11. A spinner for the manufacture of glasswool, comprising:
a rotatable peripheral sidewall; and a plurality of orifices penetrating said sidewall, said orifices being aligned at a predetermined column angle;
wherein the column angle is selected based on experimentation to minimize the thermal conductivity of fibrous insulation produced therefrom.

12. The spinner of claim 11, wherein the column angle improves the k-value of the glasswool by at least about 2 k-points with respect to glasswool of a similar fiber diameter.

13. The spinner of claim 11, wherein the column angle is approximately 30°.

14. The spinner of claim 11, wherein the column angle is approximately 22°.

15. The spinner of claim 11, wherein the column angle is approximately 45°.

16. The spinner of claim 11, wherein the column angle is approximately 68°.

17. The spinner of claim 11, further comprising:
a nonforminous band positioned at the lower end of said rotatable peripheral sidewall.

18. The spinner of claim 17, wherein said nonformainous band is between about 10% and 50% of the height of the sidewall.

19. The spinner of claim 17, wherein said foraminous band is at least 75% of the height of the sidewall.

20. The spinner of claim 11, wherein the column angle improves the k-value of the glasswool by at least about 1.5 k-points with respect to glasswool of a similar fiber diameter.
